(19) United States
(12) Patent Application Publication
(10) Pub. No.: US 2011/0224035 A1
(43) Pub. Date: Sep. 15, 2011

(54) Derailleur for Bicycle

(76) Inventor: Kristopher Wehage, Woodinville, WA (US)

(21) Appl. No.: 12/723,792

(22) Filed: Mar. 15, 2010

(51) Int. Cl. F16H 59/00

(52) U.S. Cl. 474/80

(57) ABSTRACT

A derailleur is cooperable with a bicycle including a plurality of cogs mounted thereto and is variable in positions in response to changing the speed of the bicycle and is in a position corresponding to one cog for one bicycle speed. The derailleur includes a first knuckle, a second knuckle, and a link member interconnecting and timing the first and second knuckles. The link member has an inner housing portion and an outer housing portion. The derailleur further includes two adjustment members for limiting it to the minimum and maximum range of motion and for connecting the inner and outer housing portion together.

### BACKGROUND OF THE INVENTION

1. Field of the Invention

The present invention relates to the field of bicycles and, in particular to a derailleur which is variable in positions in response to changing the speed of the bicycle and also includes adjustment members for limiting it to the minimum and maximum range of motion, and more particularly, to a novel use of adjustment members.

2. Description of the Related Art

It is known a derailleur for a bicycle is used in connection with a plurality of coaxially mounted toothed cogs, known as sprocket wheels, so as to provide the user of such bicycle with a selection of different gear-ratios to achieve a particular mechanical advantage during the operation of the bicycle. Such derailleur generally includes a first knuckle and a second knuckle and a link member interconnecting and timing the first and second knuckles, and of which the first knuckle connects the derailleur to the bicycle, and the second knuckle includes a chain guide mounted thereto and which is positionable at various positions and corresponds to one cog for one bicycle speed through pivotal motion of the link member.

In general, the link member is a 4 bar linkage such as disclosed in U.S. Pat. No. 4,259,873. However, U.S. Pat. No. 4,469,479 discusses the parallelogram linkage has some disadvantages, thus shows a link member in a shape of a box, and in which components of a timing mechanism for the first and second knuckles are disposed.

However, it is still desired to provide a derailleur which would be simple in structure and weight saving as well as provides an aesthetic appearance.

### SUMMARY OF THE INVENTION

According to the present invention, a derailleur is cooperable with a bicycle including a plurality of cogs mounted thereto and includes a first knuckle and a link member connected to the first knuckle. The link member includes an inner housing portion, an outer housing portion separately formed form one another, and a timing mechanism. The derailleur also includes a second knuckle interconnected with the first knuckle by the link member. The first and second knuckles are timed by the timing mechanism. The derailleur further includes an adjustment member limiting it to the minimum and maximum range of motions. In addition, the derailleur is characterized in that the adjustment member engages with the inner and outer housing portions so as to join them together, and with the timing mechanism accommodated in the inner and outer housing portions.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a derailleur in accordance with a first embodiment of the present invention and shows the derailleur mounted to a dropout of a bicycle, with the bicycle including a plurality of cogs mounted thereon, and with the dropout and cogs shown in phantom.

FIG. 2 is a partial, exploded perspective view of the derailleur of FIG. 1.

FIG. 3 is another perspective view of the derailleur taken from a different angle of view than that of FIG. 1.

FIG. 4 is a cross-sectional view taken along line 4-4 of FIG. 1.

FIG. 5 is a cross-sectional view taken along line 5-5 of FIG. 1.

FIG. 6 is a cross-sectional view taken along line 6-6 of FIG. 1.

FIG. 7 illustrates the derailleur limited to where its maximum range of motion is.

FIG. 8 is a cross-sectional view of the derailleur in a position corresponding to that of FIG. 7.

FIG. 9 illustrates the derailleur limited to where its minimum range of motion is.

FIG. 10 is a cross-sectional view of the derailleur in a position corresponding to that of FIG. 9.

FIG. 11 is a partial, exploded view of a derailleur in accordance with a second embodiment of the present invention.

FIG. 12 is a partial, exploded view of a derailleur in accordance with a third embodiment of the present invention.

### DETAILED DESCRIPTION OF THE PREFERRED EMBODIMENT

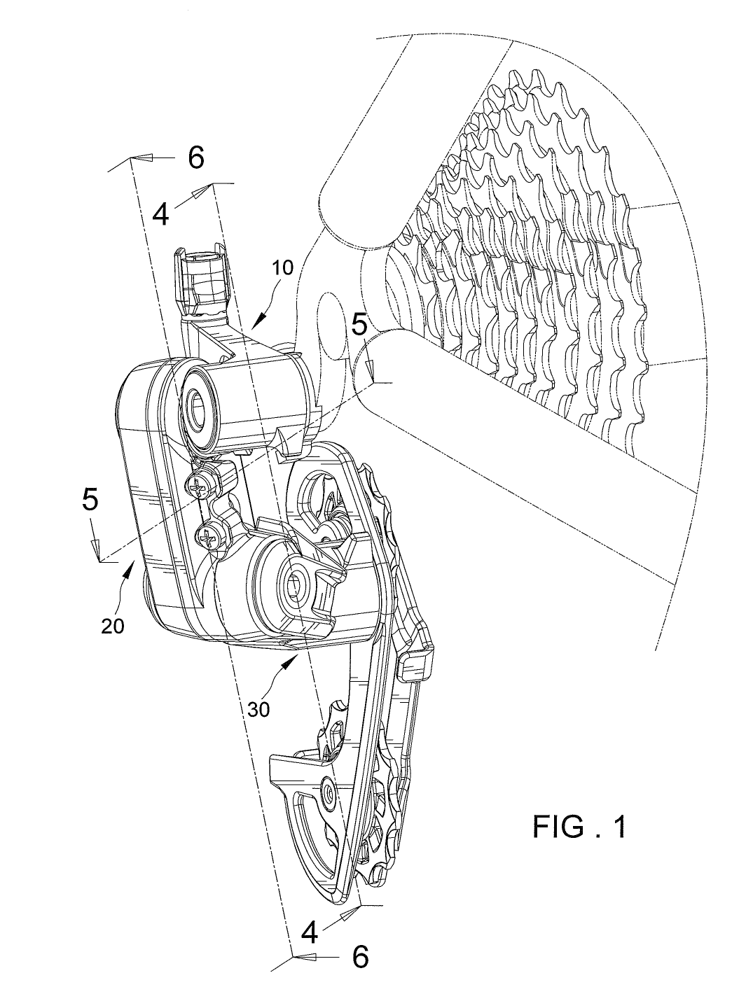

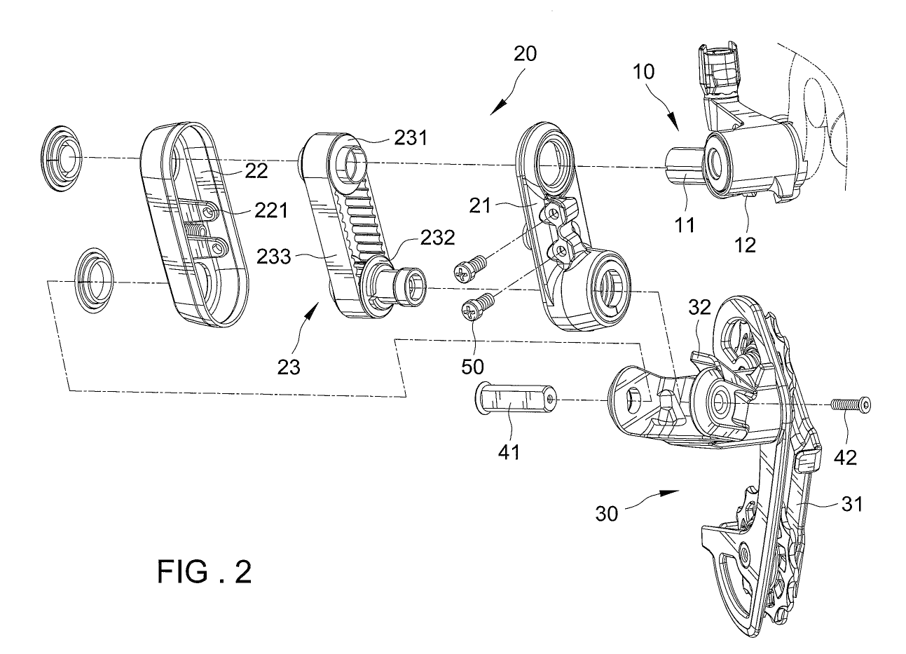

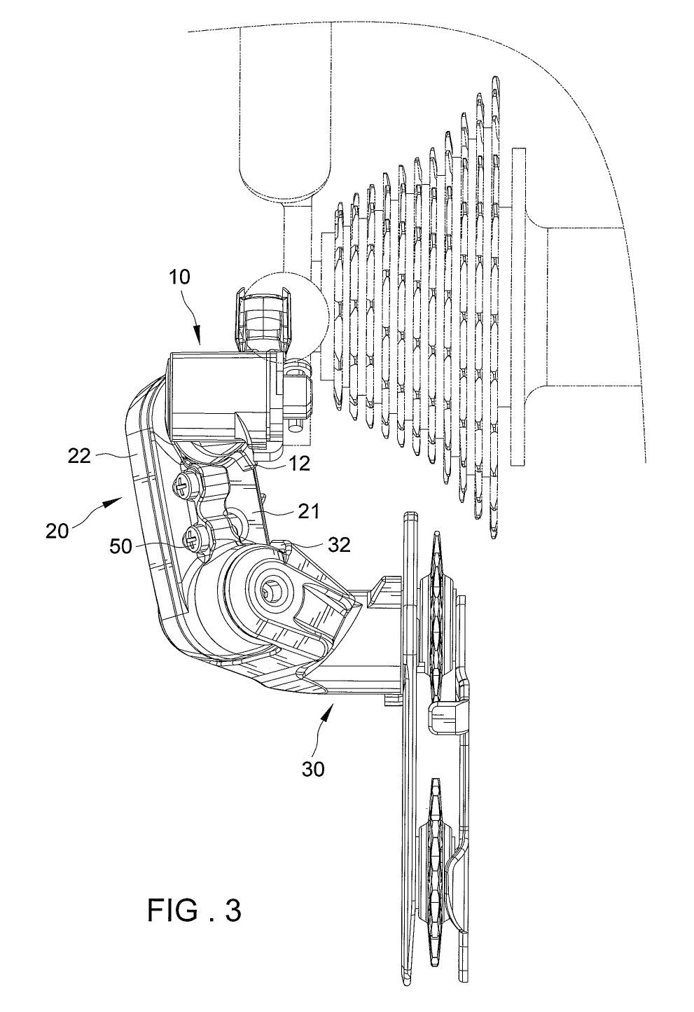

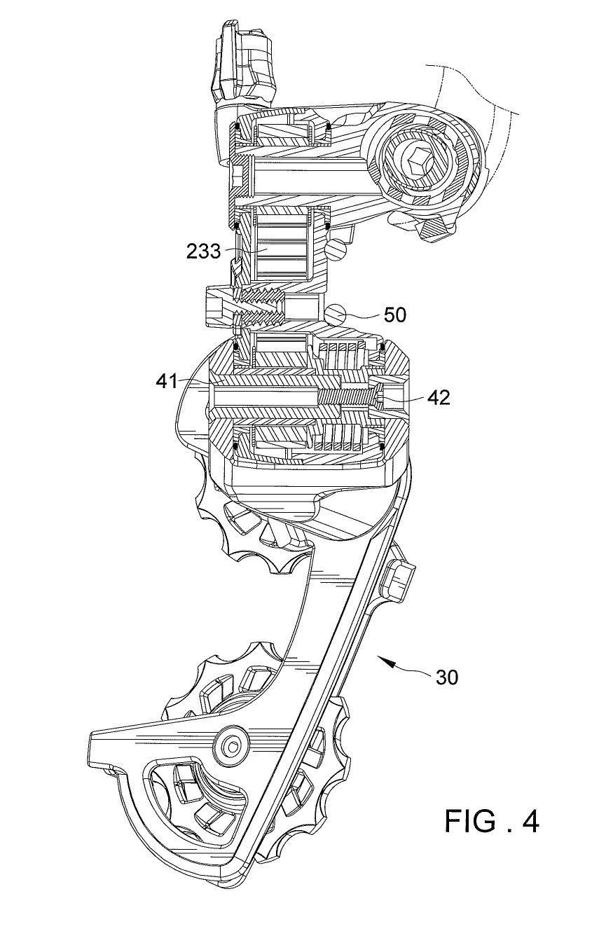

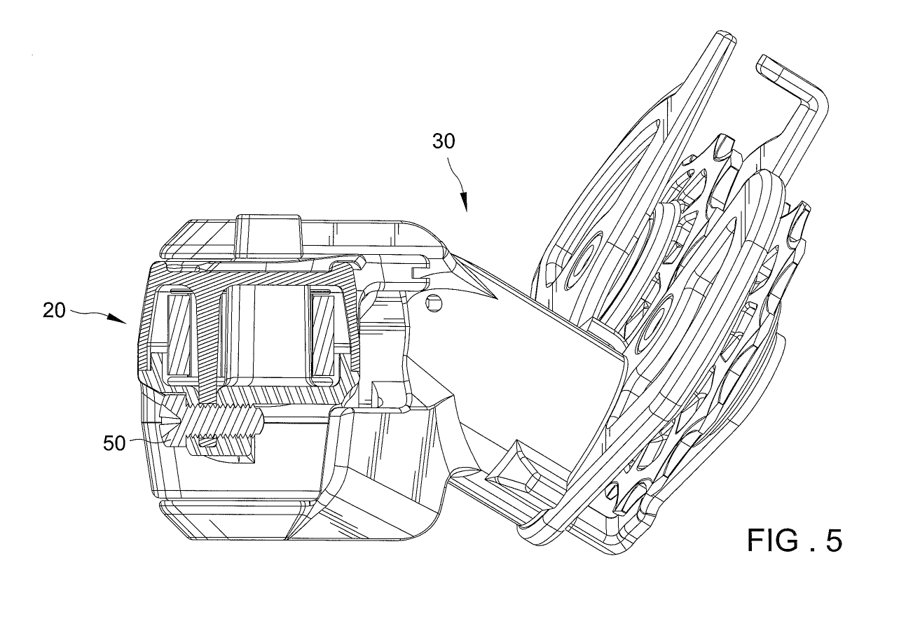

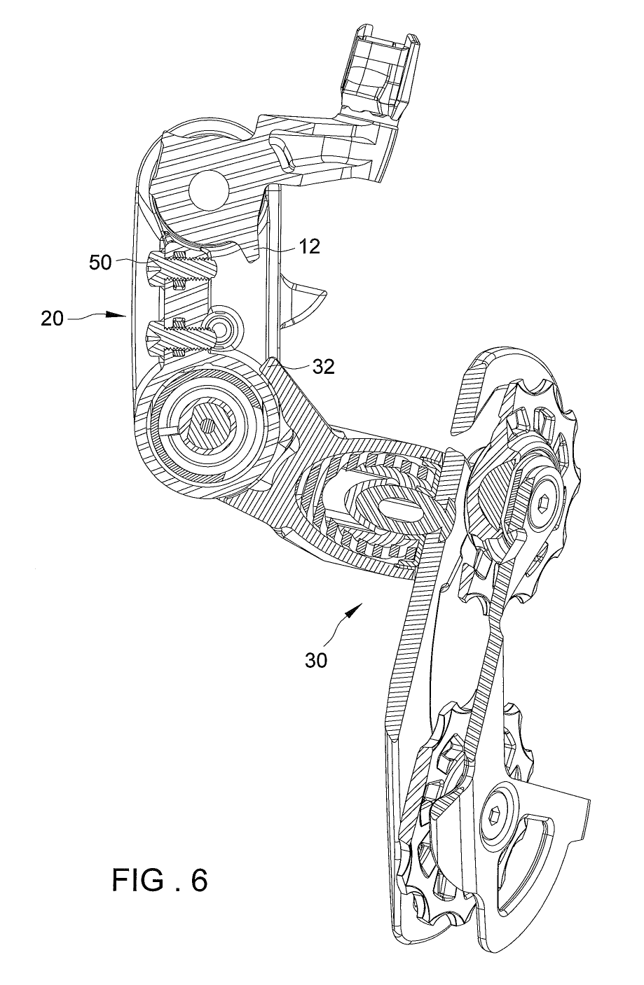

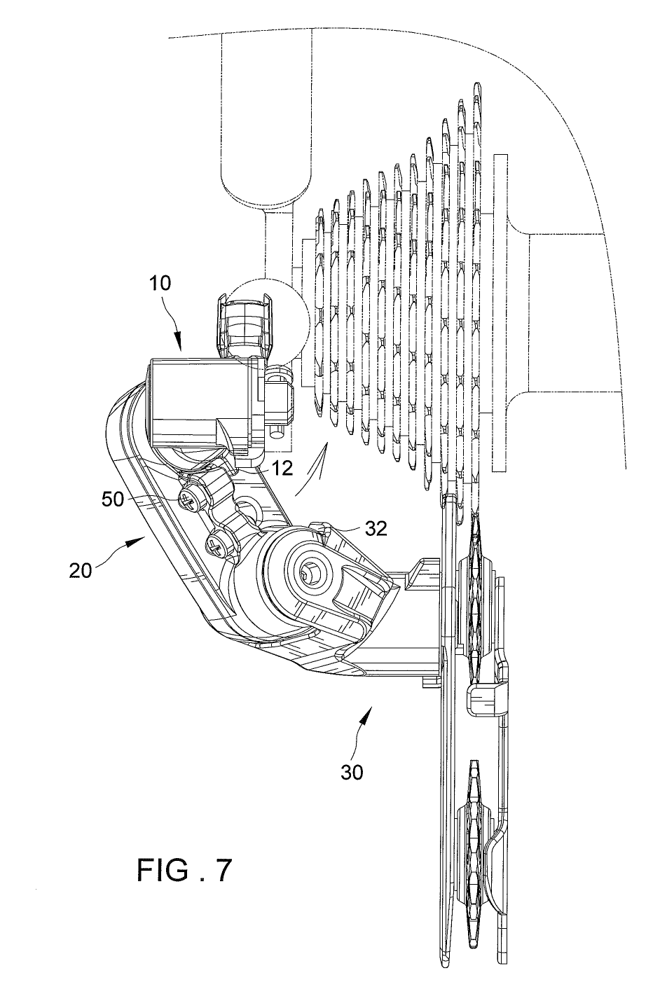

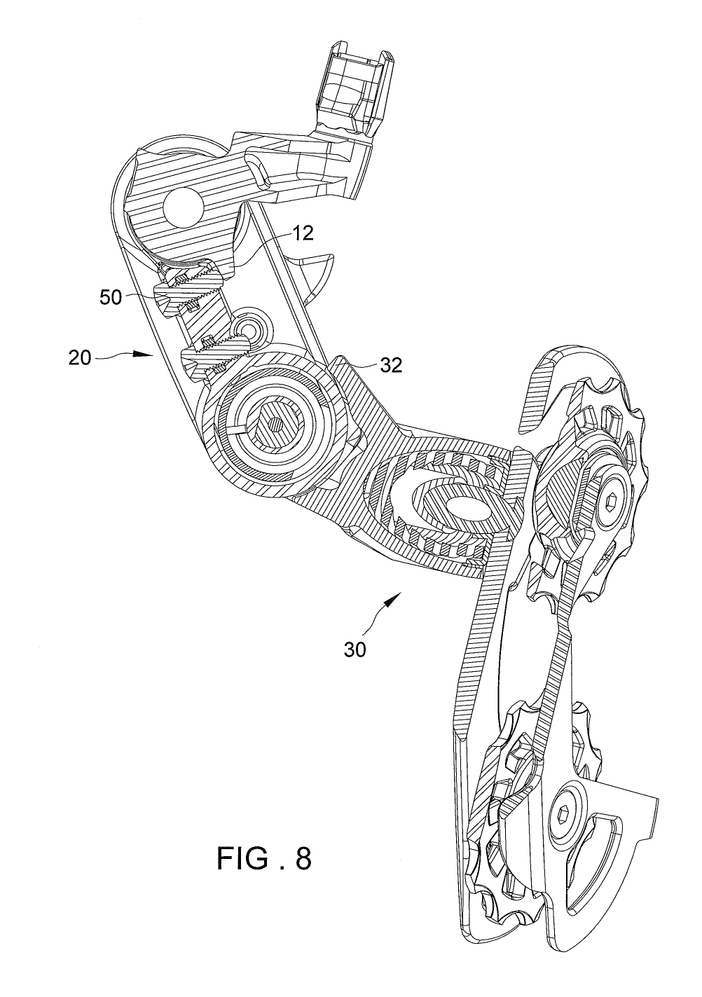

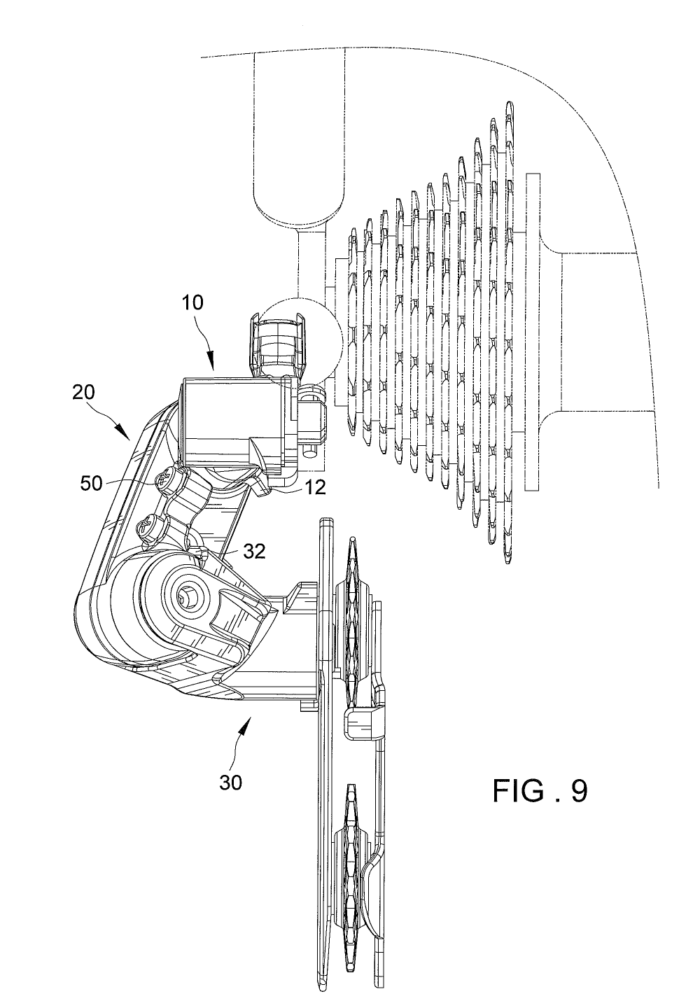

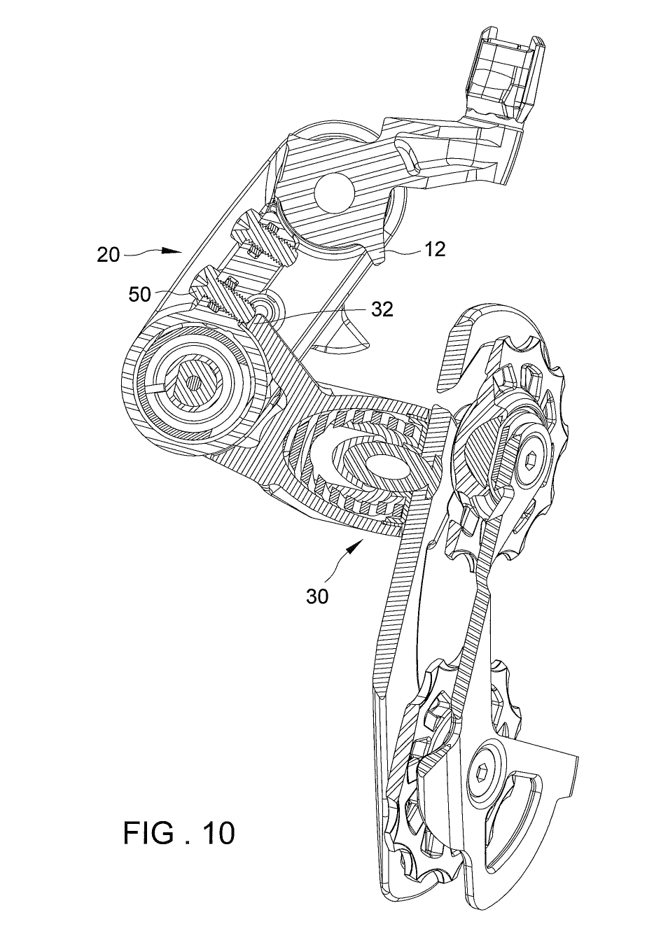

FIG. 1 through 10 show a derailleur in accordance with a first embodiment of the present invention. The derailleur is cooperable with a bicycle including a plurality of cogs mounted thereto such that the user of such bicycle is provided with a selection of different gear-ratios to achieve a particular mechanical advantage during the operation of the bicycle. Specifically, the derailleur is variable in positions in response to changing the speed of the bicycle and is in a position corresponding to one cog for one bicycle speed. The derailleur includes a first knuckle 10, a link member 20 and a second knuckle 30 interconnected with the first knuckle 10 by the link member 20. The first knuckle 10 is mounted on a frame of the bicycle and connects the link member 20 and second knuckle 30 to the bicycle. The link member 20 is pivotally engaged with the first knuckle 10 about a first axis. In the embodiment, the first knuckle 10 includes a protuberance 11 to which the link member 20 is mounted for engaging with the first knuckle 10. In addition, the link member 20 is pivotal about the protuberance 11 as the protuberance 11 extends in accordance with the first axis. The second knuckle 30 is pivotally engaged with the link member 20 about a second axis. In the embodiment, a first engaging pin 41 is cooperated with a second engaging pin 42 to connect the link member 20 and second knuckle 30 together. In addition, the second knuckle 30 is pivotal about either of the first 41 and second 42 engaging pins as both engaging pins 41 and 42 extend in accordance with the second axis. The second knuckle 30 also includes a chain guide 31 connected thereto, and which corresponds to one cog for one bicycle speed. For example, FIGS. 7 and 9 show that the chain guide 31 is disposed correspondingly to two different cogs for two bicycle speeds, respectively. In the embodiment, the chain guide 31 includes two derailleur pulleys including a top derailleur pulley and a bottom derailleur pulley mounted thereto and with which a transmission chain can engage. In addition, FIGS. 7 and 9 show the derailleur is limited to where the maximum range of motion is and where the minimum range of motion is, respectively. Specifically, the derailleur includes two adjustment members 50 mounted on the link member 20 and of that one adjustment member 50 contacts with a first limit 12 defined on the first knuckle 10 as the pivoting of the link member 20 with respect to the first knuckle 10 is limited and as the derailleur is limited to where the maximum range of motion is, and of that the other adjustment member 50 contacts with a second limit 32 defined on the second knuckle 30 as the pivoting of the second knuckle 30 with respect to the link member 20 is limited and as the derailleur is limited to where the minimum range of motion is. However, it is understood that the number of adjustment members 50 is not of limitation as it is possible that one or more adjustment member(s) 50 be implemented. In the embodiment, each of the adjustment members 50 includes an outer thread to mesh with an inner thread formed in the link member 20.

Further, a timing mechanism 23 is provided in the link member 20 to time the first 10 and second 30 knuckles. The timing mechanism 23 includes two timing gears including a top timing gear 231 and a bottom timing gear 232, and the top timing gear 231 is in a spaced relationship with the bottom timing gear 232. In the embodiment, each of the top 231 and bottom 232 timing gears includes an outer periphery with a plurality of teeth. The timing mechanism 23 also includes a timing belt or chain 233 engaged with the top 231 and bottom 232 timing gears so as to time the top 231 and bottom 232 timing gears simultaneously. In the embodiment, the timing belt or chain 233 is in the form of a belt and is made of a material which is pliable and includes an inner periphery with a plurality of teeth with which the teeth of the engaged top 231 and bottom 232 timing gears engage. In addition, the link member 20 includes separately formed inner 21 and outer 22 housing portions to be joined together for housing the timing mechanism 23, and the inner housing portion 21 is disposed on one of two opposing sides of the timing mechanism 23 while the outer housing portion 22 is disposed on the other of two opposing sides. In the present invention, it is a novel use of the adjustment members 50 to engage with the inner 21 and outer 22 housing portions together such that the inner housing portion 21 is joined with and prevented from disengagement from outer housing portion 22. In the embodiment, the outer housing portion 22 includes two lug holes 221 that the adjustment members 50 can extend therethrough respectively when the outer housing portion 22 is joined to the inner housing portion 21.

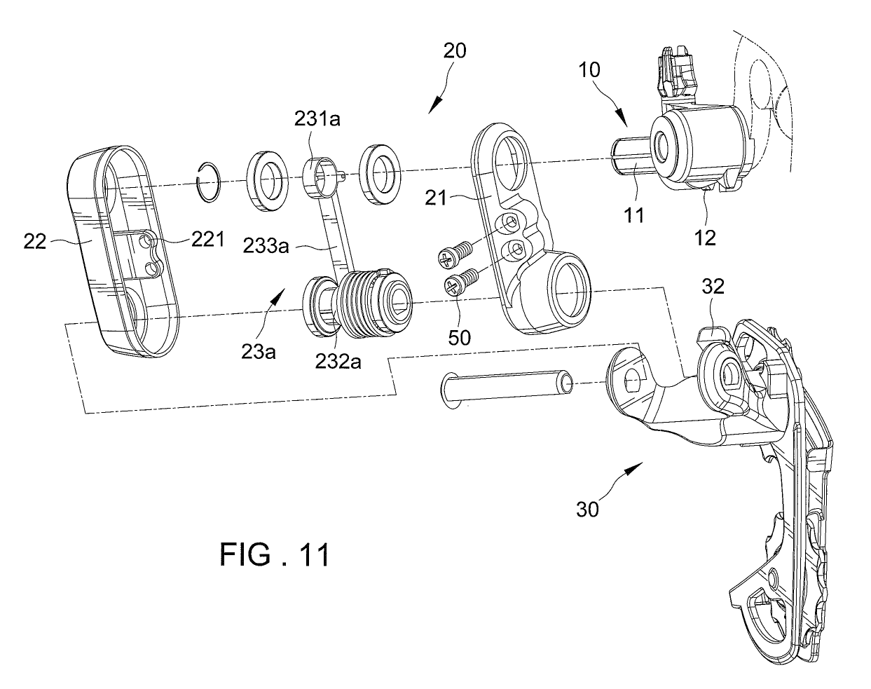

FIG. 11 shows a derailleur in accordance with a second embodiment of the present invention, and wherein the same numerals are employed to denote the like components, except bearing a suffix “a”. The second embodiment differentiates from the first embodiment in that it substitutes a timing mechanism 23a for the timing mechanism 23. The timing mechanism 23a includes two timing gears including a top timing gear 231a and a bottom timing gear 232a, and the top timing gear 231a is in a spaced relationship with the bottom timing gear 232a. Unlike the first embodiment, each of the top 231a and bottom 232a timing gears is without a plurality of teeth formed thereon. The timing mechanism 23a also includes a tie rod 233a articulating the top 231a and bottom 232a timing gears so as to time the top 231a and bottom 232a timing gears simultaneously. Unlike the first embodiment, the tie rod 233a is without a plurality of teeth formed thereon.

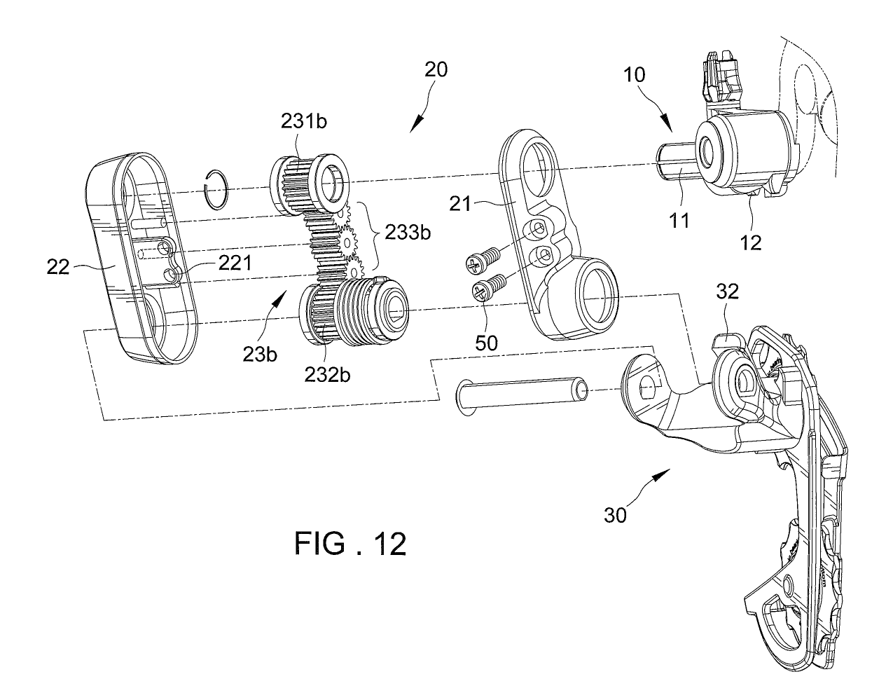

FIG. 12 shows a derailleur in accordance with a third embodiment of the present invention, and wherein the same numerals are employed to denote the like components, except bearing a suffix “b”. The third embodiment differentiates from the first embodiment in that it substitutes a timing mechanism 23b for the timing mechanism 23. The timing mechanism 23b includes two timing gears including a top timing gear 231b and a bottom timing gear 232b, and the top timing gear 231b is in a spaced relationship with the bottom timing gear 232b. Like the first embodiment, each of the top 231b and bottom 232b timing gears has an outer periphery with a plurality of teeth. The timing mechanism 23a also includes a plurality of gears 233b collectively engaged with the top 231b and bottom 232b timing gears so as to time the top 231b and bottom 232b timing gears simultaneously. In the embodiment, each of the plurality of gears 233b includes an outer periphery with a plurality of teeth.

In addition, it is understood that the link member could also be a 4 bar linkage.

While the specific embodiments have been illustrated and described, numerous modifications come to mind without significantly departing from the spirit of invention, and the scope of invention is only limited by the scope of the accompanying claims.

What is claimed is:

1. A derailleur is cooperable with a bicycle including a plurality of cogs mounted thereto, comprising:
a first knuckle;
a link member connected to the first knuckle and including an inner housing portion and an outer housing portion separately formed form one another, and with the link member further including a timing mechanism;
a second knuckle interconnected with the first knuckle by the link member;
a first limit;
a second limit; and
an adjustment member; and
wherein the timing mechanism times the first and second knuckles; and
wherein the adjustment member contacts with the first limit as the derailleur is limited to where the maximum range of motion is and contacts with the second limit as the derailleur is limited to where the minimum range of motion is; and
wherein the adjustment member engages with the inner and outer housing portions so as to join them together, and with the timing mechanism accommodated in the inner and outer housing portions.

2. The derailleur as claimed in claim 1 wherein the timing mechanism includes a top timing gear and a bottom timing gear disposed in a spaced relationship with the first timing gear.

3. The derailleur as claimed in claim 2 wherein each of the first and second timing gears includes an outer periphery with a plurality of teeth.

4. The derailleur as claimed in claim 3 wherein the timing mechanism includes a timing belt or chain engaged with the top and bottom timing gears so as to time the top and bottom timing gears, and wherein the timing belt or chain includes an inner periphery with a plurality of teeth with which the teeth of the engaged top and bottom timing gears engage.

5. The derailleur as claimed in claim 3 wherein the timing mechanism includes a plurality of gears collectively engaged with the top and bottom timing gears so as to time the top and bottom timing gears, and wherein each of the plurality of gears includes an outer periphery with a plurality of teeth.

6. The derailleur as claimed in claim 2 wherein the timing mechanism includes a tie rod articulating the top and bottom timing gears so as to time the top and bottom timing gears.

7. The derailleur as claimed in claim 1 wherein the adjustment member includes an outer thread to mesh with an inner thread formed in the link member.
